(19) United States
(12) Patent Application Publication
(10) Pub. No.: US 2006/0238819 A1
(43) Pub. Date: Oct. 26, 2006

(54) PROCESSING MANIPULATION UTILIZING GRAPHICAL USER INTERFACE

(75) Inventor: KOHEI KAWAMURA, Kawasaki-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/379,711

(22) Filed: Apr. 21, 2006

(30) Foreign Application Priority Data
Apr. 25, 2005 (JP) 2005-126720
Apr. 19, 2006 (JP) 2006-116173

(51) Int. Cl. H04N 1/23

(52) U.S. Cl. 358/302; 358/448

(57) ABSTRACT

Disclosed is an information processing apparatus having an input unit and a display unit and means for implementing a graphical user interface using the input unit and display unit, the apparatus including: an operation specifying unit that specifies a type of input operation performed by the input unit; a first processing unit that executes first processing associated with the type of input operation specified by the operation specifying unit; a processing re-designating unit that makes a designation in such a manner that processing different from the first processing, which has been executed by the first processing unit, is executed; and a second processing unit that executes second processing in accordance with the designation made by the processing re-designating unit, the second processing being different from the first processing and associated with the type of input operation specified by the operation specifying unit.

### FIELD OF THE INVENTION

This invention relates to an information processing apparatus and method. More particularly, the invention relates to an information processing apparatus and method for executing an application utilizing a graphical user interface.

### BACKGROUND OF THE INVENTION

A method involving a graphical user interface for issuing an input instruction to an information processing apparatus by an intuitive operation and presenting a display of a processing result that conforms to this instruction is an input/display method most widely employed by general users.

With such an input/display method, processing as intended by a user can be executed intuitively by a pointing device typified by a mouse, enabling operations such as the editing, moving and copying not only of text but also of objects such as images. However, because such operations can be carried out intuitively, erroneous operations by the user, though few, do occur. There are also cases where obtainable results of an operation intended by the user through a simple operation by a mouse of the like are limited. For example, there are cases where the operation of pointing at an object and dragging it by a mouse is considered intuitively by some users to be a copying operation while other users may consider it to be a moving operation.

A function whereby the state that prevailed prior to the processing can be restored in a case where the result of the processing is not in line with the intentions of the user owing to an operation based upon such erroneous recognition is generally well known (By way of example, see “Excel 2002 at a Glance”, by Hidetoshi Sugimatsu, Natsume Inc., Jul. 20, 2001, pp. 52-53). Another generally known method is to display a list of processing candidates before the results of processing are displayed and allow the user to select a candidate in a case where it cannot be determined solely from a user operation which processing is to be executed (For example, see the specification of Japanese Patent Application Laid-Open No. 8-95732).

However, labor is required on the part of the user in cases where the user has performed an erroneous operation or in cases where processing results in line with user intentions are not obtained, as mentioned above. Specifically, upon performing an operation to restore the state that prevailed prior to the processing, the user must perform the correct operation or re-perform an operation that is for obtaining the processing results intended by the user. Further, in a case where it cannot be ascertained what operation to perform to obtain the intended processing results even though an operation that restores the state that prevailed prior to the processing has been carried out, the user must repeatedly perform an operation of restoring the state that prevailed prior to the processing after an erroneous operation or must refer to an operating manual.

Further, with the method of displaying a list of processing candidates, the user may not be able to ascertain which selection item in the list is the processing intended and must eventually refer to an operating manual or repeatedly perform an operation of restoring the state that prevailed prior to the processing after an erroneous operation has been performed.

### SUMMARY OF THE INVENTION

The present invention has been devised in consideration of the circumstances set forth above and its object is to so arrange it that if a processing result desired by a user is not obtained by a user operation in a case where processing is specified using a graphical user interface, the processing result desired by the user is obtained through fewer operations.

According to the present invention, the foregoing object is attained by providing an information processing apparatus having an input unit and a display unit for implementing a graphical user interface, the apparatus comprising:

an operation specifying unit that specifies a type of input operation performed by the input unit;

a first processing unit that executes first processing associated with the type of input operation specified by the operation specifying unit;

a processing re-designating unit that makes a designation in such a manner that processing different from the first processing, which has been executed by the first processing unit, is executed; and

a second processing unit that executes second processing in accordance with the designation made by the processing re-designating unit, the second processing being different from the first processing and associated with the type of input operation specified by the operation specifying unit.

According to the present invention, the foregoing object is also attained by providing an information processing method executed by an information processing apparatus having an input unit and a display unit for implementing a graphical user interface, the method comprising:

an operation specifying step of specifying a type of input operation performed by the input unit;

a first processing step of executing first processing associated with the type of input operation specified by the operation specifying unit;

a processing re-designating step of making a designation in such a manner that processing different from the first processing, which has been executed at the first processing step, is executed; and

a second processing step of executing second processing in accordance with the designation made at the processing re-designating step, the second processing being different from the first processing and associated with the type of input operation specified at the operation specifying step.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate an embodiment/embodiments of the invention and, together with the description, serve to explain the principles of the invention.

FIG. 1 is a block diagram schematically illustrating a configuration of an information providing system according to an embodiment of the present invention;

FIG. 2 is a block diagram schematically illustrating a structure of an information processing apparatus according to the embodiment of the present invention;

FIG. 3 is a flowchart illustrating processing executed when a photograph on a tray is assigned to an album page according to the embodiment of the present invention;

FIG. 4 is a flowchart illustrating processing executed when a photograph on an album page is enlarged according to the embodiment of the present invention;

FIG. 5 is a diagram illustrating an example of a user interface when a photograph on a tray is assigned to an album page according to the embodiment of the present invention;

FIG. 6 is a diagram illustrating an example of a user interface when a photograph on a tray is assigned to an album page according to the embodiment of the present invention;

FIG. 7 is a diagram illustrating an example of a user interface when a photograph on a tray is assigned to an album page according to the embodiment of the present invention;

FIG. 8 is a diagram illustrating an example of a user interface when a photograph on a tray is assigned to an album page according to the embodiment of the present invention;

FIG. 9 is a diagram illustrating an example of a user interface when a photograph on an album page is enlarged according to the embodiment of the present invention;

FIG. 10 is a diagram illustrating an example of a user interface when a photograph on an album page is enlarged according to the embodiment of the present invention;

FIG. 11 is a diagram illustrating an example of a user interface when a photograph on an album page is enlarged according to the embodiment of the present invention;

FIG. 12 is a diagram illustrating an example of a user interface when a photograph on an album page is enlarged according to the embodiment of the present invention;

FIG. 13 is a diagram illustrating an example of a user interface when a photograph on an album page is enlarged according to the embodiment of the present invention;

FIG. 14 is a diagram illustrating another example of a user interface when a photograph on a tray is assigned to an album page according to the embodiment of the present invention;

FIG. 15 is a diagram illustrating another example of a user interface when a photograph on a tray is assigned to an album page according to the embodiment of the present invention;

FIG. 16 is a diagram illustrating an operation specifying table used in an electronic album editing application according to the embodiment of the present invention;

FIG. 17 is a diagram illustrating a processing function table used in the electronic album editing application according to the embodiment of the present invention;

FIG. 18 is a diagram illustrating a substitute processing table used in the electronic album editing application according to the embodiment of the present invention; and

FIG. 19 is a diagram illustrating an area information table used in the electronic album editing application according to the embodiment of the present invention.

### DETAILED DESCRIPTION OF THE PREFERRED EMBODIMENT

A preferred embodiment of the present invention will be described in detail in accordance with the accompanying drawings. In this embodiment, a case where the present invention is applied to an electronic album editing application in which an image file is an object will be described as processing that employs a graphical user interface.

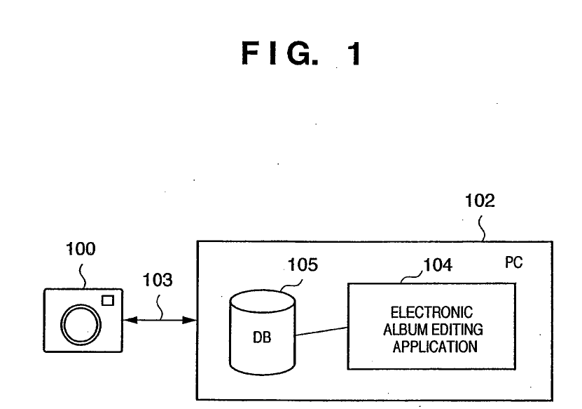

FIG. 1 is a block diagram schematically illustrating the functional configuration of an information providing system according to the embodiment of the present invention. The system includes an image input unit 101 capable of converting an optical image to an electrical signal, applying prescribed image processing to the signal and then recording the result as digital information. The following devices can be used as the image input unit 101, by way of example: a digital camera capable of taking a still picture and recording it as image data; a digital video camera capable of shooting a moving picture and recording it as moving image data; and a scanner capable of reading an original and outputting it as image data. Further, instead of a device that converts an optical image to an electrical signal and records it as image data, use may be made of drivers of various storage media capable of reading and outputting image data from a storage media on which image data has been stored.

The system further includes a user computer (PC) 102 and a data-transfer interface 103 for transferring captured image data between the image input unit 101 and PC 102. Examples of the data-transfer interface 103 that can be used are a USB (Universal Serial Bus), a wired interface typified by IEEE 1394, and a wireless interface typified by IrDA and Bluetooth. It should be noted that the present invention is not limited by the type of interface.

Image data that has been acquired by the image input unit 101 is transferred to a storage area of an information storage device, which is typified by a hard-disk drive (HDD) in the PC 102, via the data-transfer interface 103. There are two cases in which image data is transferred from the image input unit 101 to the PC 102. The first is a case where image data that has been stored in the information storage device of the image input unit 101 is transferred collectively in response to an instruction from the operating system or special-purpose software installed in the PC 102. The second is a case where image data is transferred to a data recording area reserved in an information storage section of the PC 102 by the operating system of the PC 102 or special-purpose software in response to a transfer command sent from the image input unit 101.

An electronic album editing application 104 having a graphical user interface is capable of running on the PC 102, and image data in the PC 102 is edited using the electronic album editing application 104. A database (DB) 105 for storing user data is an information storage device for various data used in processing by the electronic album editing application 104. The information storage device typified by the hard-disk drive of the PC 102 may be just as well be utilized instead of the database 105.

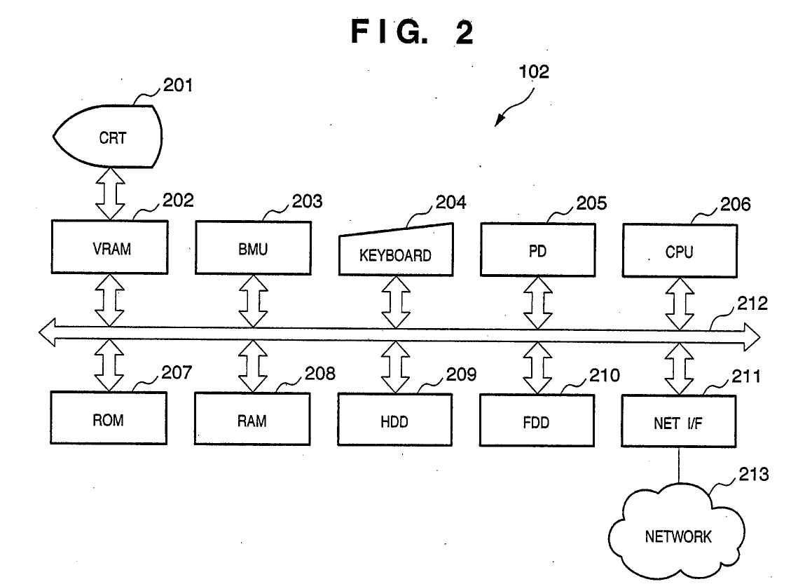

FIG. 2 is a block diagram schematically illustrating the structure of an information processing apparatus that corresponds to the PC 102 according to the preferred embodiment of the present invention.

As shown in FIG. 2, the apparatus includes a display unit such as a CRT or LCD (referred to as “CRT”, hereinafter) on the display screen of which are displayed documents, figures or images currently being edited, editing information, icons, messages, menus and other user interface information, by way of example. A VRAM 202 stores a generated image for being displayed on the display screen of the CRT 201. Image data that has been stored in the VRAM 202 is transferred to the CRT 201 in accordance with a prescribed rule, whereby an image is displayed on the CRT 201. A bit-move unit (BMU) 203 controls data transfer between memories (e.g., between the VRAM 202 and another memory) as well as data transfer between a memory and each input/output device (e.g., a network interface 211). A keyboard 204 has various keys for inputting characters, etc. A pointing device 205 is used to designate icons, menu items and other objects displayed on the display screen of the CRT 201.

A CPU 206 controls various devices, which have been connected to the CPU, based upon a control program that has been stored on a storage medium such as a ROM 207, a hard disk, a floppy (registered trademark) disk or CD-ROM. The ROM 207 holds various control programs and data. A RAM 208 has a work area for the CPU 206, a save area for saving data at the time of error processing, and a load area for loading a control program. A hard-disk drive (HDD) 209 is capable of storing each control program, which is executed within the information processing apparatus, and various contents. For example, electronic album data and an electronic album editing program are stored on the hard-disk drive 209 of the PC 102. The apparatus further includes a drive 210 of any type of storage medium such as a floppy (registered trademark) disk drive (FDD), CD-ROM drive or compact flash (registered trademark) card drive (referred to as “FDD”, hereinafter). A network interface 211 is capable of communicating with another information processing apparatus (not shown) or printer, etc., via a network 213. A CPU bus 212 includes an address bus, a data bus and a control bus. A control program executed by the CPU 206 can be provided from the ROM 207, HDD 209 or FDD 210 or from another information processing apparatus via the network 213.

Processing executed when a photograph on a tray is assigned to an album page and processing executed when a photograph on an album page is enlarged will now be described as specific examples of cases where the present invention is applied to an electronic album editing application that is run on the information processing apparatus having the structure set forth above.

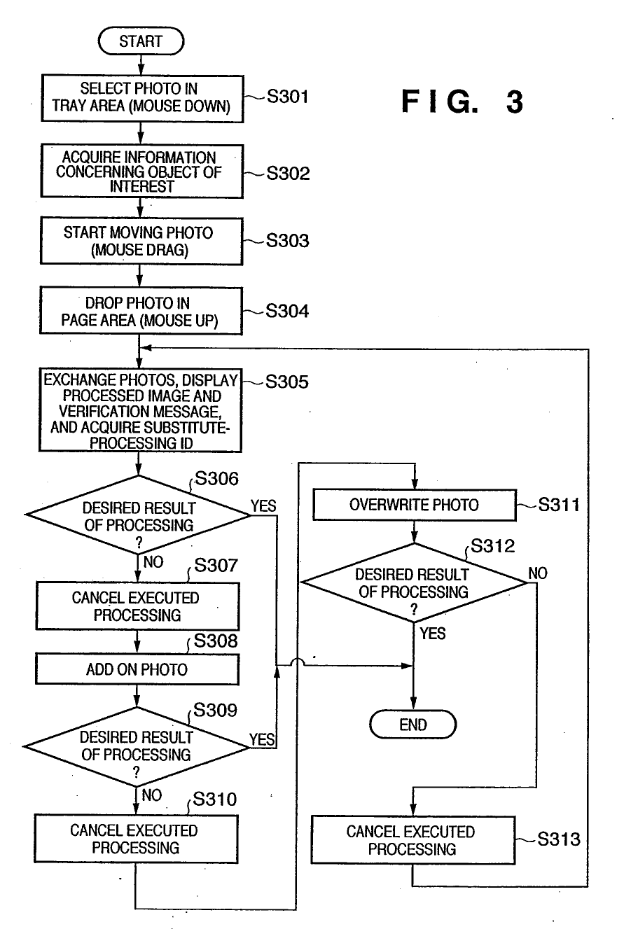

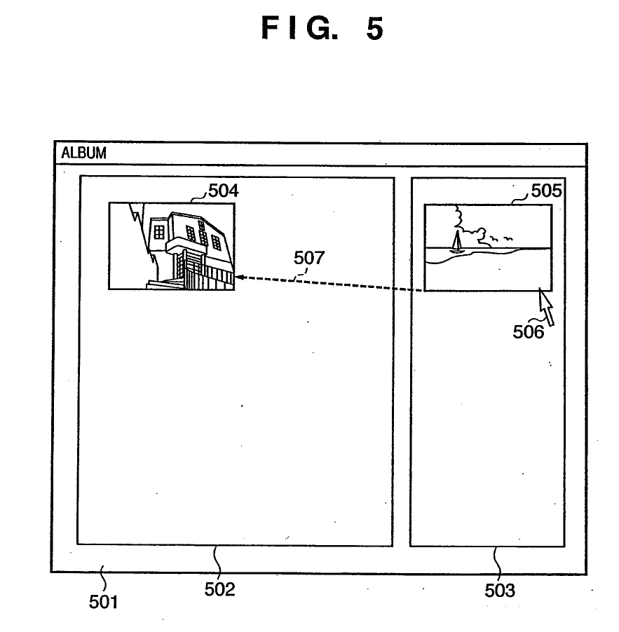

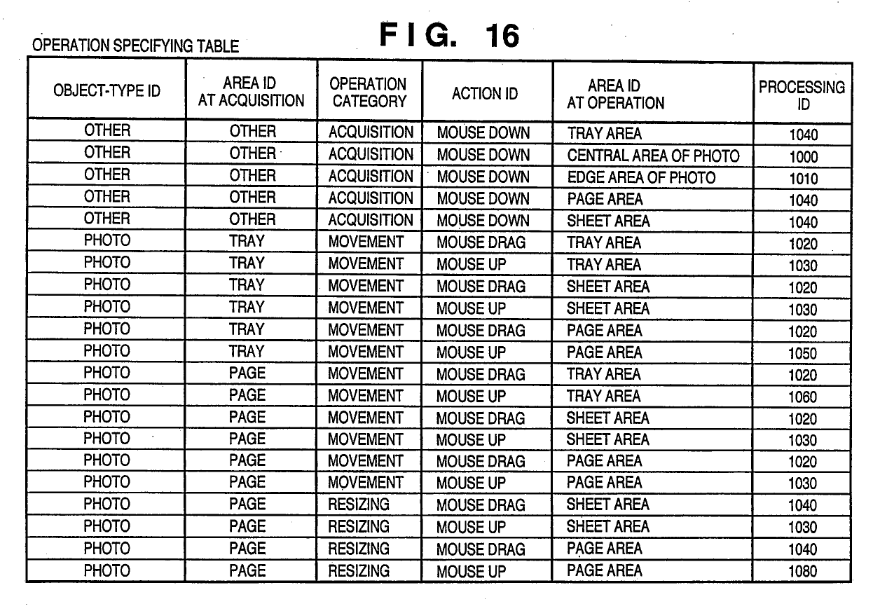

First, processing executed when a photograph on a tray is assigned to an album page will be described with reference to the flowchart of FIG. 3. FIGS. 5 to 8 illustrate an example of a user interface displayed on the CRT 201 in the processing shown in FIG. 3. Further, FIGS. 16 to 19 illustrate tables that store various data used in the electronic album editing application.

As illustrated in FIG. 5, assume that a photograph 504 is being displayed on a page 502 placed on a sheet 501, and that a photograph 505 is being displayed on a tray 503 placed on the sheet 501. While observing a pointer 506 that moves in association with manipulation of the pointing device 205, the user can select an object (referred to as “mouse down” below), move the object (referred to as “mouse drag” below) and complete movement of the object (referred to as “mouse up” below). Processing executed when the user performs an operation that includes dragging the photograph 505 by the pointer 506 and dropping it on the page 502, as indicated by arrow 507, is as set forth below.

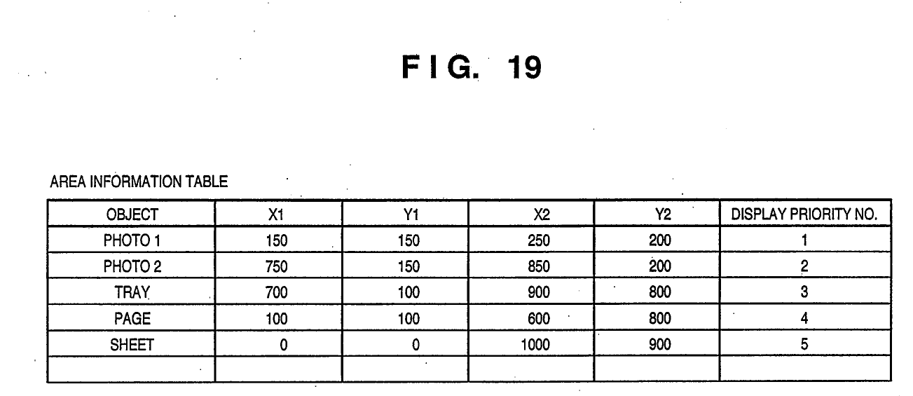

In the state shown in FIG. 5, the user selects the photograph 505, which is in the area of tray 503, by mouse down using the pointer 506 at step S301 in FIG. 3. Mouse-down position information is acquired as coordinates (x,y), in which the upper-left corner of the sheet 501 is the origin and the X and Y directions (horizontal and vertical directions, respectively) are the coordinate axes. An area information table shown in FIG. 19 is a table indicating the present positions of objects present in an album.

Stored in the area information table are coordinates (X1,Y1,X2,Y2) of rectangles in which the coordinates of the upper-left corner of each object are (X1,Y1) and the coordinates of the lower-right corner are (X2,Y2), as well as display priority numbers. By discriminating where in the area of the coordinates (X1,Y1,X2,Y2) the mouse-down position information is contained, which object is being selected can be determined. Cases where objects overlap must be taken into account, and in a case where the mouse-down coordinates fall within the coordinate areas of a plurality of objects, the object having the smallest display priority number is adopted as the selected object. It should be noted that the coordinates (X1,Y1,X2,Y2) of each object and the display priority numbers are dynamic data that change at mouse up following the dragging or editing of an object. Further, in a case where a selected object is a photograph, whether the mouse-down coordinates are in the central area of the photograph or in a edge area of the photograph is discriminated. In this embodiment, what percentage of the entire coordinate area of a photograph is occupied by the central area of the photograph is defined in advance. If the coordinates are within this coordinate area, it is determined by calculation that the mouse-down coordinates belong to the central area. Otherwise, it is determined by calculation that the mouse-down coordinates belong to the edge area of the photograph.

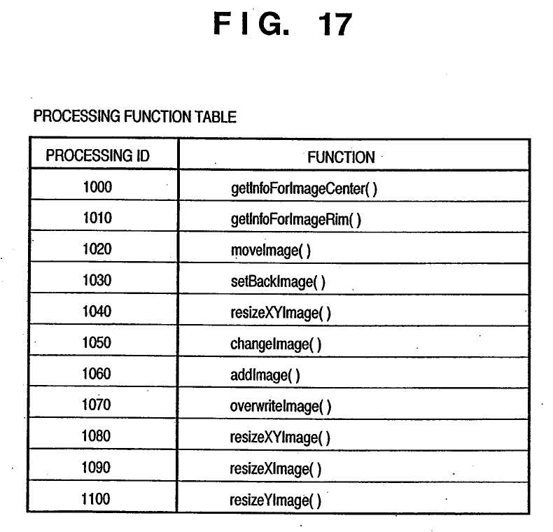

Next, at step S302, the selected object information is acquired. An operation specifying table shown in FIG. 16 is a table for retrieving one processing ID based upon an object-type ID, area ID at acquisition, operation category, action ID and area ID at acquisition. It should be noted that one processing ID can be retrieved solely by action ID and area ID at acquisition only when mouse down is performed. In case of move processing, mouse down is performed in the central area of a photograph and therefore “1000” is obtained as the processing ID. A processing function table illustrated in FIG. 17 is a table for retrieving a function by processing ID. Here a search is conducted based upon processing ID “1000” and a function “getInfoForImageCenter( )” is obtained. The function “getInfoForImageCenter( )” acquires the coordinates of the object, decides the object-type ID from the object and the area ID at acquisition from the coordinates at the time of acquisition and makes the operation category “MOVE”. Here the object-type ID obtains “PHOTO”, the operation category obtains “MOVEMENT” and the area ID at acquisition obtains “TRAY”.

If mouse drag of the photograph 505 is performed at step S303, then the processing ID is obtained by searching the operation specifying table of FIG. 16 based upon the object-type ID, area ID at acquisition, operation category, action ID and area ID at operation acquired at step S302. Here “MOUSE DRAG” is acquired for action ID and “TRAY AREA” is acquired for area ID at operation. On the basis of these search conditions, “1020” is acquired as the processing ID from the operation specifying table of FIG. 16. Furthermore, the processing ID “1020” is retrieved from the processing function table of FIG. 17 and the function “moveImage( ) is obtained. Here “moveImage( )” is a function for deciding the present position of photograph coordinates by adding or subtracting amount of movement after mouse drag to or from the coordinates pointed to, and re-displaying the photograph. If mouse drag is performed on a sheet or page, the area ID at operation becomes “SHEET AREA” or “PAGE AREA”. However, since the processing ID obtained in this case is “1020” regardless, the acquisition function is “moveImage( )”, which is the same as that mentioned above.

Mouse up of photograph 505 is performed in the area of page 502 at step S304. Here also the operation-specifying table of FIG. 16 is searched and the processing ID is acquired in similar fashion. Since object-type ID retrieves “PHOTO”, area ID at acquisition retrieves “TRAY”, operation category retrieves “MOVEMENT”, action ID retrieves “MOUSE UP” and area ID at operation retrieves “PAGE AREA”, “1050” is obtained as the processing ID. The function “changeImage( )” is obtained by searching the processing function table of FIG. 17 based upon “1050”.

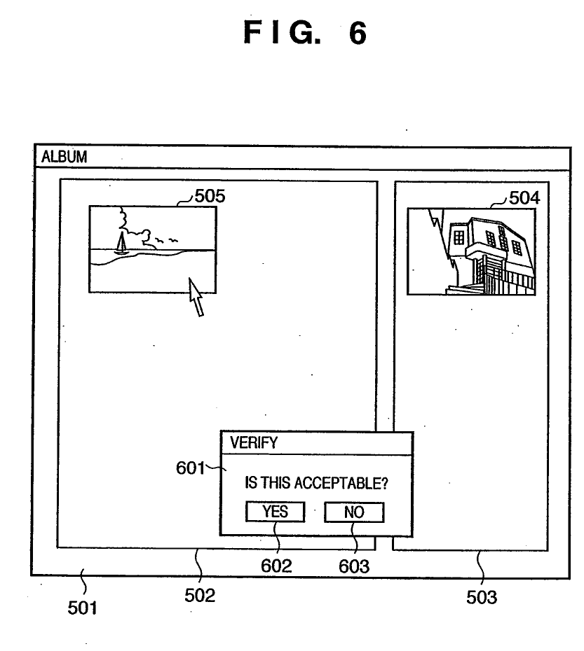

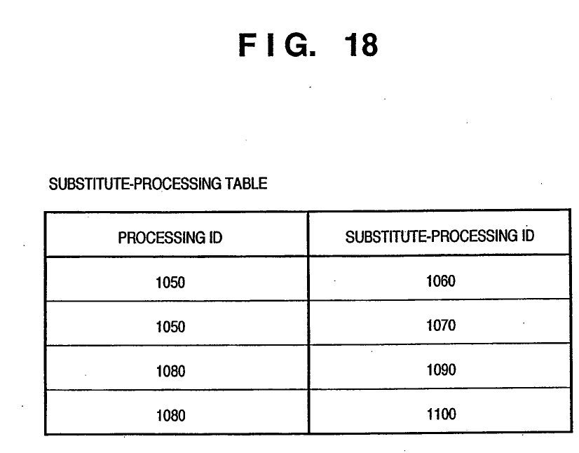

Next, at step S305, the acquired function “changeImage( )” is executed, an exchange of photographs is performed and the result is displayed. The function “changeImage( )” exchanges the photograph 504, which has been discriminated from the coordinates of the pointer at mouse up based upon the area information table, for the acquired photograph 505 obtained at step S301, and displays the photograph 505 (see FIG. 6). Furthermore, the function updates the area information table of FIG. 19 to coordinates (X1,Y1,X2,Y2) resulting from the exchange, and updates the priority number. A substitute processing table in FIG. 18 is a table for retrieving a substitute-processing ID based upon processing ID. In a case where a retrieved processing ID does not exist among processing IDs of the substitute processing table, the processing of FIG. 3 ends. Since substitute processing does exist, a message 601 that prompts the user to decide whether the result obtained is the desired result of processing is displayed, as shown in FIG. 6, and the processing ID in the substitute processing table is acquired. Here “1050” is acquired as the processing ID from the operation specifying table of FIG. 16. Accordingly, “1060” and “1070” are acquired as substitute-processing IDs from the substitute processing table of FIG. 18.

If the user observes the displayed result, determines whether this is the desired processing and presses a “YES” button 602 indicating that the result of processing is the desired result (“YES” at step S306), then processing ends. Conversely, if the user decides that the displayed result is different from that intended and presses a “NO” button 603 indicating that the result of processing is not the desired result (“NO” at step S306), then control proceeds to step S307. Here the photograph exchange processing that was executed at step S305 is cancelled, the state that prevailed prior to this processing (the state shown in FIG. 5) is restored and then control proceeds to step S308. Note that this cancellation processing only needs to be performed internally and it is unnecessary to display the result of the cancellation processing.

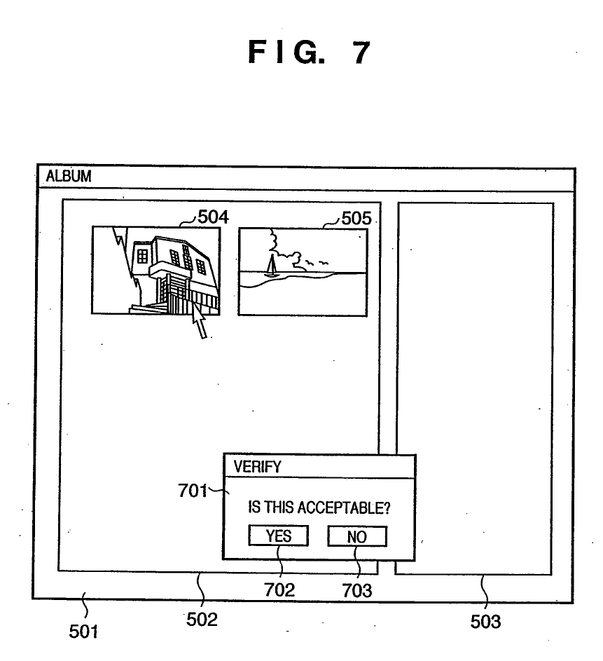

At step S308, the first substitute-processing ID of the substitute-processing IDs acquired at step S305 is acquired, the processing IDs of the processing function table of FIG. 17 are searched based upon the acquired substitute-processing ID, a function is acquired, this function is executed and the results are displayed again. Here the function “addImage( )” is acquired owing to the search conducted based upon “1060”, which is the first substitute-processing ID. The function “addImage( )” re-displays the photograph 505, which was selected at step S301, upon placing it in a blank area devoid of a photograph on the page 502 (see FIG. 7), and displays a message 701 that prompts the user to verify whether the result obtained is the desired result. Further, the function updates the coordinates (X1,Y1,X2,Y2) of the relevant object in the area information table of FIG. 19 to the coordinates prevailing after the exchange, and updates the priority number.

FIG. 7 illustrates a screen on which the photograph 505 has been moved from the tray 503 and placed alongside the photograph 504 and the verification message 701 is being displayed. Since the result of the cancellation processing at step S307 is not displayed, the screen changes from the state shown in FIG. 6 to the state shown in FIG. 7. If the user observes the displayed result, decides that this is the desired result of processing and presses a “YES” button 702 that indicates that the result is the desired result of processing (“YES” at step S309), then processing ends. On the other hand, if the user decides that the displayed result is different from that intended and presses a “NO” button 703 indicating that the result of processing is not the desired result (“NO” at step S309), then control proceeds to step S310. Here the photograph add-on processing that was executed at step S308 is cancelled, the state that prevailed prior to this processing (the state shown in FIG. 5) is restored and then control proceeds to step S311. Here again, this cancellation processing only needs to be performed internally and it is unnecessary to display the result of the cancellation processing.

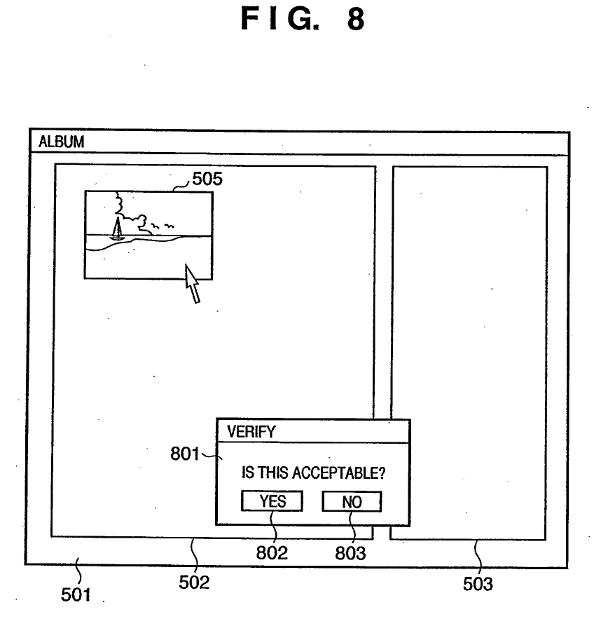

At step S311, the second substitute-processing ID of the substitute-processing IDs acquired at step S305 is acquired, the processing IDs of the processing function table of FIG. 17 are searched based upon the acquired substitute-processing ID, a function is acquired, this function is executed and the results are displayed again. Here the function “overwriteImage( )” is acquired owing to the search conducted based upon “1070”, which is the second substitute-processing ID. The function “overwriteImage( )” re-displays the photograph 505, which was selected at step S301, upon superimposing it on the photograph 504 on page 502 (see FIG. 8). Furthermore, the function updates the coordinates (X1,Y1,X2,Y2) of the object that is photograph 505 in the area information table of FIG. 19 to the coordinates that prevail after the placement of the photograph, and updates the priority number. The photograph 504 that has been overwritten is dealt with as being deleted. A photograph after the deletion thereof is not discussed in this example. However, a so-called “trash can” icon used generally nowadays may be prepared and the deleted photographs may be saved here, by way of example.

Further, at step S311, a message 801 that prompts the user to verify whether the result of processing obtained is correct is displayed, as illustrated in FIG. 8. Note that since the result of the cancellation processing at step S310 is not displayed, the screen changes from the state shown in FIG. 7 to the state shown in FIG. 8. If the user observes the displayed result, decides that this is the desired result of processing and presses a “YES” button 802 that indicates that the result is the desired result of processing (“YES” at step S312), then processing ends. On the other hand, if the user decides that the displayed result is different from that intended and presses a “NO” button 803 indicating that the result of processing is not the desired result (“NO” at step S312), then control proceeds to step S313. Here the photograph overwrite processing that was executed at step S311 is cancelled, the state that prevailed prior to this processing (the state shown in FIG. 5) is restored and then control returns to step S305. This cancellation processing needs to be performed internally and it is unnecessary to display the result of the cancellation processing. Steps S305 to S313 are repeated as long as the user presses the “NO” button.

It should be noted that it may be so arranged that steps S305 to S312 need not be repeated as long as the user presses the “NO” button. Rather, it may be so arranged that in a case where the “NO” button 803 has been pressed at step S312, the photographs 504 and 505 are returned to the state that prevailed prior to processing (the positions shown in FIG. 5). Further, it may be so arranged that processing is exited in a case where steps S305 to S312 are executed a prescribed number of times.

Further, the processing described above with reference to the flowchart of FIG. 3 illustrates a case where a photograph in tray 503 is dropped on the page area 502. However, the object dropped is not limited to an object within an electronic album editing application and may be a file or object that has been recognized by other software. The reason for this is that even if a file or object is one that has been recognized by other software, implementation is possible if there is compatibility that allows the album editing application to recognize this object.

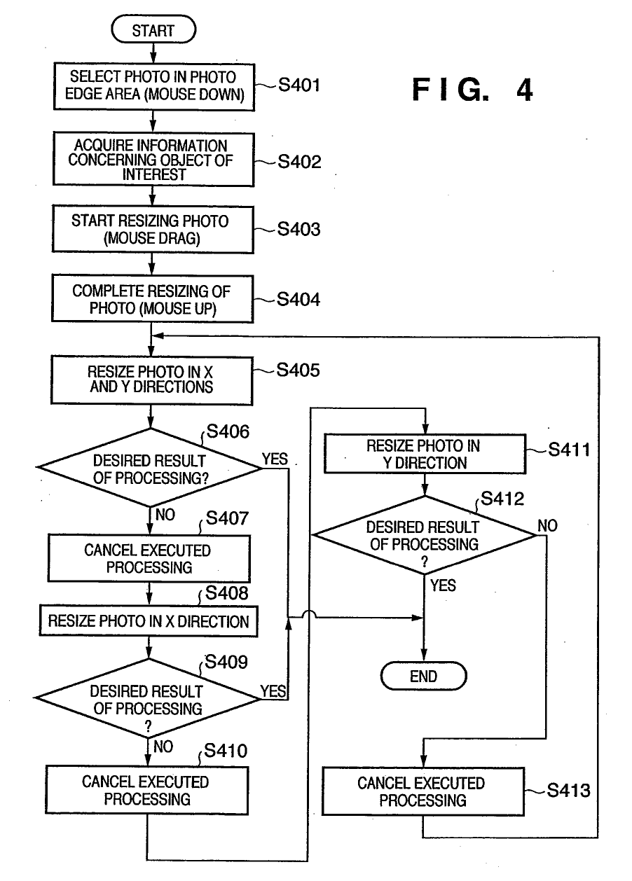

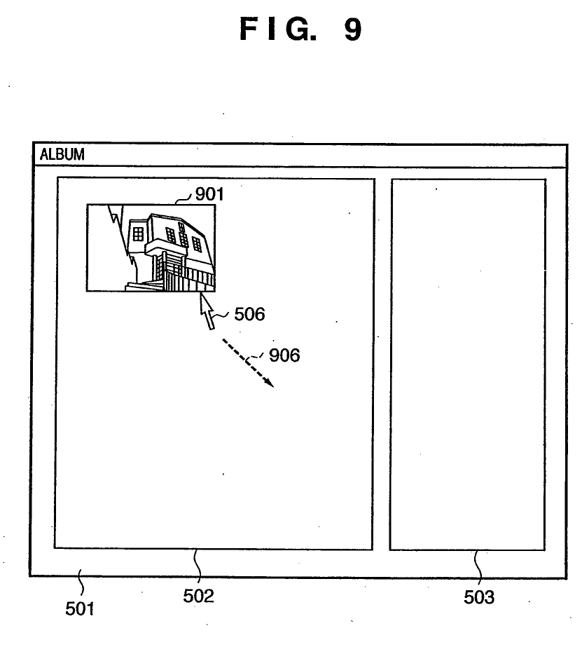

Next, reference will be had to the flowchart of FIG. 4 to describe processing executed when a photograph on an album page is enlarged in an electronic album editing application according to this embodiment. FIGS. 9 to 13 illustrate a user interface displayed on the CRT 201 in the processing shown in FIG. 4. Various tables illustrated in FIGS. 16 to 19 are used in this enlargement processing.

As illustrated in FIG. 9, assume that a photograph 901 is being displayed on the page 502 on the sheet 501. While observing the pointer 506 that moves in association with manipulation of the pointing device 205, the user can select an object by mouse down, resize the object by mouse drag and complete resizing of the object by mouse up. Processing executed when the user performs an operation that includes enlarging the photograph 901 by the pointer 506 in a direction indicated by arrow 906 in FIG. 9 is as set forth below.

In the state shown in FIG. 9, the user selects the photograph 901, which is in the area of page 502, by mouse down using the pointer 506 at step S401 in FIG. 4. In a manner similar to that of the processing executed at step S301, mouse-down position information is acquired as coordinates (x,y) in which the upper-left corner of the sheet 501 is the origin and the X and Y directions (horizontal and vertical directions, respectively) are the coordinate axes.

In a case where the object selected by the user at step S401 is a photograph, the area ID at operation, which indicates whether the mouse-down coordinates are in the central area of the photograph or in a edge area of the photograph, is discriminated from the operation-specifying table of FIG. 16. The method of discriminating whether the position is in the central area of the photograph or in a edge area of the photograph is as described above.

Next, at step S402, the selected object information is acquired. A processing ID is obtained by searching the operation specifying table of FIG. 16 based upon the action ID and area ID at operation. In case of enlargement processing, the edge area of the photograph is designated by mouse down and therefore the processing ID “1010” is obtained. Furthermore, a function is obtained by searching the processing function table of FIG. 17 based upon the processing ID. Here a search is conducted based upon processing ID “1010” and a function “getInfoForImageRim( )” is obtained. The function “getInfoForImageRim( )” acquires the coordinates of the object, decides the object-type ID from the object and the area ID at acquisition from the coordinates at the time of acquisition and makes the operation category “RESIZING”. Here the object-type ID is “PHOTO”, the operation category is “RESIZING” and the area ID at acquisition is “PAGE”.

If mouse drag of the photograph 901 is performed at step S403, then the processing ID is obtained by searching the operation-specifying table of FIG. 16 based upon the object-type ID, area ID at acquisition, operation category, action ID and area ID acquired at step S402. Here “MOUSE DRAG” is acquired for action ID and “PAGE AREA” is acquired for the area ID at operation. On the basis of these search conditions, “1040” is acquired as the processing ID from the operation-specifying table of FIG. 16. Furthermore, the processing ID “1040” is retrieved from the processing function table of FIG. 17 and the function “resizeXYImage( ) is obtained. Here “resizeXYImage( )” is a function for resizing the photograph by adding or subtracting amount of movement after mouse drag to or from solely the coordinates (X2,Y2), and re-displaying the photograph. Furthermore, the function updates the area information table of FIG. 19 to the coordinates (X1,Y1,X2,Y2) prevailing after resizing, and updates the priority number.

Mouse up of photograph 901 is performed in the area of page 502 at step S404. Here also the operation-specifying table of FIG. 16 is searched and the processing ID is acquired in similar fashion. Since object-type ID retrieves “PHOTO”, area ID at acquisition retrieves “PAGE”, operation category retrieves “RESIZING”, action ID retrieves “MOUSE UP” and area ID at operation retrieves “PAGE AREA”, “1080” is obtained as the processing ID. The function “resizeXYImage( )” is obtained by searching the processing function table of FIG. 17 based upon processing ID “1080”.

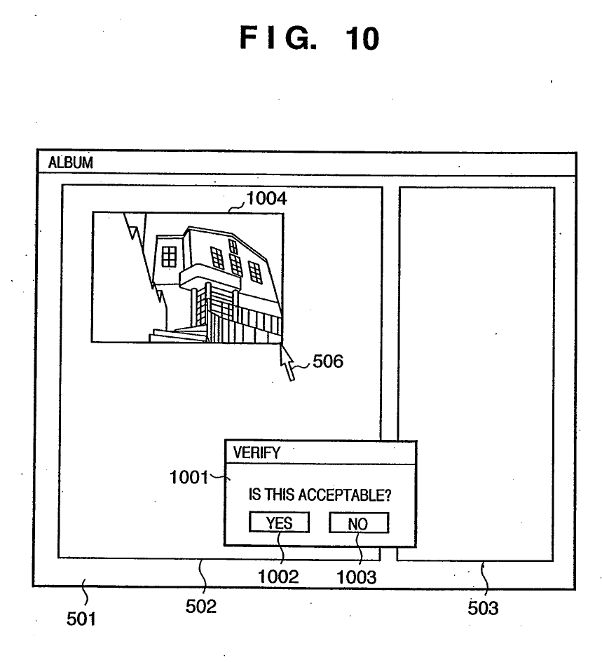

Next, at step S405, the acquired function “resizeXYImage( )” is executed, image enlargement is performed and the result is displayed (see FIG. 10). The processing according to function “resizeXYImage( )” is as described above. In a case where a retrieved processing ID does not exist among processing IDs of the substitute processing table of FIG. 18, processing ends. Since substitute processing does exist, a message 1001 that prompts the user to decide whether the result obtained is the desired result of processing is displayed, as shown in FIG. 10, and the processing ID in the substitute processing table is acquired. Here “1080” is acquired as the processing ID from the operation specifying table of FIG. 16. Accordingly, “1090” and “1100” are acquired as substitute-processing IDs from the substitute processing table of FIG. 18.

If the user observes the displayed result, determines whether this is the desired processing and presses a “YES” button 1002 indicating that the result of processing is the desired result (“YES” at step S406), then processing ends. Conversely, if the user decides that the displayed result is different from that intended and presses a “NO” button 1003 indicating that the result of processing is not the desired result (“NO” at step S406), then control proceeds to step S407. At step S407, the XY-direction resize processing of the photograph that was executed at step S405 is cancelled, the state that prevailed prior to this processing (the state shown in FIG. 9) is restored and then control proceeds to step S408. Note that this cancellation processing only needs to be performed internally and it is unnecessary to display the result of the cancellation processing.

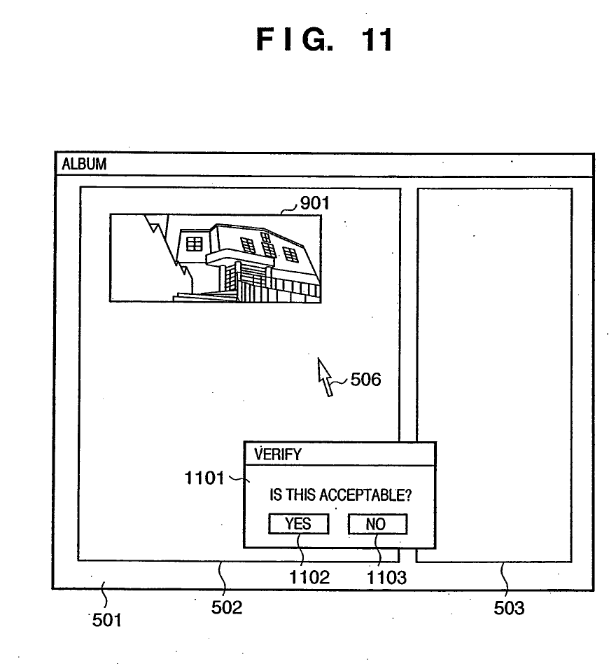

At step S408, the first substitute-processing ID of the substitute-processing IDs acquired at step S405 is acquired, the processing IDs of the processing function table of FIG. 17 are searched based upon the acquired substitute-processing ID, a function is acquired, this function is executed and the results are displayed again. Here the function “resizeXImage( )” is acquired owing to the search conducted based upon “1090”, which is the first substitute-processing ID. The function “resizeXImage( )” re-displays the photograph 901, which was selected at step S401, upon enlarging the photograph only along the X direction (see FIG. 11) and displays a message 1101 that prompts the user to verify whether the result obtained is the desired result. Note that since the result of the cancellation processing at step S407 is not displayed, the screen changes from the state shown in FIG. 10 to the state shown in FIG. 11. Further, the function updates the coordinates (X1,Y1,X2,Y2) of the relevant object in the area information table of FIG. 19 to the coordinates prevailing after enlargement, and updates the priority number.

FIG. 11 illustrates a screen on which the photograph 901 has been enlarged along only the X direction and the verification message 1100 is being displayed. If the user observes the displayed result, decides that this is the desired result of processing and presses a “YES” button 1102 that indicates that the result is the desired result of processing (“YES” at step S409), then processing ends. On the other hand, if the user decides that the displayed result is different from that intended and presses a “NO” button 1103 indicating that the result of processing is not the desired result (“NO” at step S409), then control proceeds to step S410. Here the photograph X-direction resize processing that was executed at step S408 is cancelled, the state that prevailed prior to this processing (the state shown in FIG. 9) is restored and then control proceeds to step S411. Here again, this cancellation processing only needs to be performed internally and it is unnecessary to display the result of the cancellation processing.

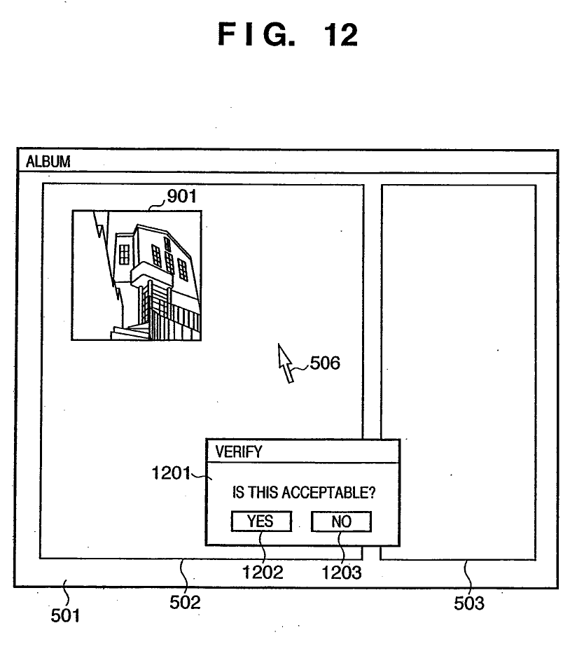

At step S411, the second substitute-processing ID of the substitute-processing IDs acquired at step S405 is acquired, the processing IDs of the processing function table of FIG. 17 are searched based upon the acquired substitute-processing ID, a function is acquired, this function is executed and the results are displayed again. Here the function “resizeYImage( )” is acquired owing to the search conducted based upon “1100”, which is the second substitute-processing ID. The function “resizeYImage( )” re-displays the photograph 901, which was selected at step S401, upon enlarging it solely along the Y direction (see FIG. 12), updates the coordinates (X1,Y1,X2,Y2) of the relevant object in the area information table of FIG. 19 to the coordinates that prevail after the enlargement of the photograph, and updates the priority number.

Further, at step S411, a message 1201 that prompts the user to verify whether the result of processing obtained is correct is displayed, as illustrated in FIG. 12. Note that since the result of the cancellation processing at step S410 is not displayed, the screen changes from the state shown in FIG. 11 to the state shown in FIG. 12. If the user observes the displayed result, decides that this is the desired result of processing and presses a “YES” button 1202 that indicates that the result is the desired result of processing (“YES” at step S412), then processing ends. On the other hand, if the user decides that the displayed result is different from that intended and presses a “NO” button 1203 indicating that the result of processing is not the desired result (“NO” at step S412), then control proceeds to step S413. At step S413, the photograph Y-direction resize processing that was executed at step S411 is cancelled, the state that prevailed prior to this processing (the state shown in FIG. 9) is restored and then control returns to step S405. This cancellation processing needs to be performed internally and it is unnecessary to display the result of the cancellation processing. Steps S405 to S413 are repeated as long as the user presses the “NO” button.

It should be noted that it may be so arranged that steps S405 to S412 need not be repeated as long as the user presses the “NO” button. Rather, it may be so arranged that in a case where the “NO” button 1203 has been pressed at step S412, the photograph 901 is returned to the state that prevailed prior to processing (the size shown in FIG. 9). Further, it may be so arranged that processing is exited in a case where steps S405 to S412 are executed a prescribed number of times.

In accordance with this embodiment as described above, the user verifies the result of processing executed in accordance with an operation that has been performed by the user intuitively. If the user decides that the result is not the desired processing result and presses a “NO” button, then other processing presumed to follow the operation performed by the user is executed and the result of this processing is displayed. Thus, in the event that the result of processing is not the desired result, the user need perform only a single operation to be able to verify the result of other processing.

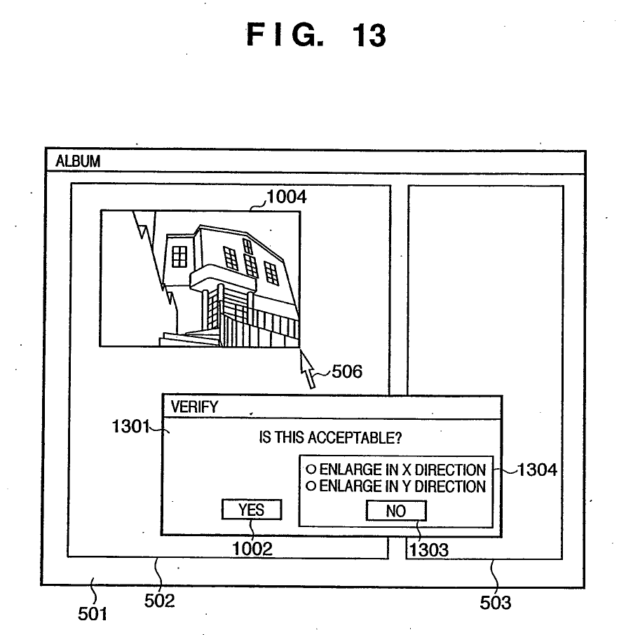

This embodiment has been described with regard to a case where there are two types of substitute-processing candidates (i.e., three types of processing per one user operation). However, it may be so arranged that a display of the kind shown in FIG. 13 is presented if there are many candidates for substitute processing. That is, along with the result of processing, a processing candidate list 1304 and a “CHANGE” button 1303 are displayed instead of the “NO” button as a verification message 1301. This expedient enables the user to select the desired processing, thereby making operation more simple. More specifically, if the user decides that the result of processing differs from that intended, then the user selects the intended processing from the processing candidate list 1304 and presses the “CHANGE” button 1303. As a result, the user is rapidly guided to the desired processing result.

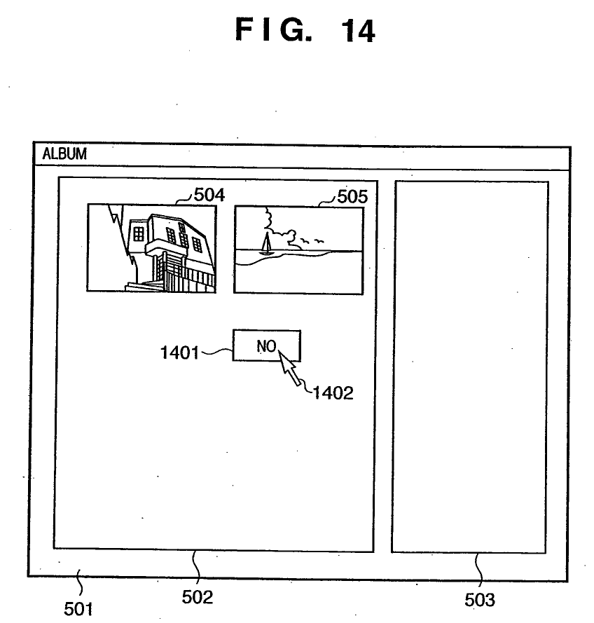

Further, the above embodiment explains an arrangement in which a verification message is displayed after the processing, however, it is so arranged that only a “NO” button is displayed. FIG. 14 illustrates a screen on which only a “NO” button is displayed in place of a verification message. In this case, when a user presses the “NO” button 1401, the same processing that the “NO” button 703 in FIG. 7 is pressed is performed. Further, any area other than the “NO” button 1401 is pressed, the same processing that the “YES” button 702 is pressed is performed and the processing is fixed. With this arrangement, selection operation is further simplified.

Furthermore, when displaying the “NO” button 1401, a pointer 1402 may be displayed so as to point the “NO” button 1401. This display is realized by controlling a display position of the pointer 1402 on the basis of the coordinates of the “NO” button 1401. Conversely, a display position of the “NO” button 1401 may be controlled on the basis of the coordinates of the displayed pointer 1402. With this arrangement, a user need not perform operation to move the pointer 1402 to the “NO” button 1401, which further simplifies the operation.

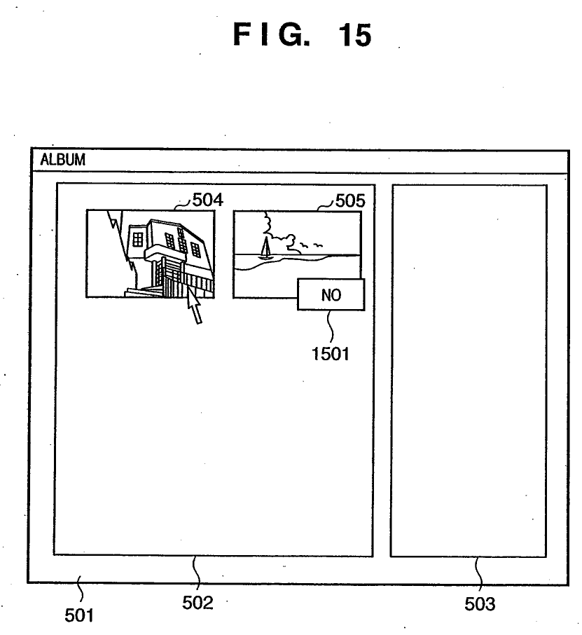

Alternatively, as shown in FIG. 15, a message or a “NO” button 1501 may be displayed over the object subjected to the processing. In this case, a display position of the message or the “NO” button 1501 is controlled on the basis of the object ID and the coordinates of the object subjected to the processing.

Further, the dimensions, shapes and relative placement of the components that constitute the graphical user interface exemplified in this embodiment may be modified appropriately depending upon the applied application and various conditions, and the present invention is not limited to the illustrated examples.

Further, in the embodiment set forth above, a case where the present invention is applied to an electronic album editing application is described as an example. However, it goes without saying that the invention can be applied to various applications that manage files by a graphical user interface.

As many apparently widely different embodiments of the present invention can be made without departing from the spirit and scope thereof, it is to be understood that the invention is not limited to the specific embodiments thereof except as defined in the appended claims.

This application claims the benefit of Japanese Application No. 2005-126720, filed Apr. 25, 2005, 2006-116173, filed Apr. 19, 2006, which are hereby incorporated by reference herein in their entirety.

What is claimed is:

1. An information processing apparatus having an input unit and a display unit for implementing a graphical user interface, said apparatus comprising:
an operation specifying unit that specifies a type of input operation performed by the input unit;
a first processing unit that executes first processing associated with the type of input operation specified by said operation specifying unit;
a processing re-designating unit that makes a designation in such a manner that processing different from the first processing, which has been executed by said first processing unit, is executed; and
a second processing unit that executes second processing in accordance with the designation made by said processing re-designating unit, said second processing being different from the first processing and associated with the type of input operation specified by said operation specifying unit.

2. The apparatus according to claim 1, further comprising a display control unit that controls to display results of the processing executed by said first and second processing units on the display unit.

3. The apparatus according to claim 1, further comprising a canceling unit that cancels the first processing by said first processing unit in accordance with the designation made by said processing re-designating unit,
wherein said second processing unit executes the second processing after the cancellation of the first processing by said canceling unit.

4. The apparatus according to claim 2, wherein said display control unit displays an icon, which is for designating whether processing result of the first processing is to be accepted or not, on the display unit together with the result of processing of the first processing; and
if the fact that the result of processing is not to be accepted has been made by an input operation by the input unit, then said processing re-designating unit makes a designation in such a manner that processing different from the first processing is executed.

5. The apparatus according to claim 1, wherein said operation specifying unit specifies the type of input operation based upon in what area on a screen displayed on the display unit the input operation has been made.

6. An information processing method executed by an information processing apparatus having an input unit and a display unit for implementing a graphical user interface, said method comprising:
an operation specifying step of specifying a type of input operation performed by the input unit;
a first processing step of executing first processing associated with the type of input operation specified by said operation specifying unit;
a processing re-designating step of making a designation in such a manner that processing different from the first processing, which has been executed at said first processing step, is executed; and
a second processing step of executing second processing in accordance with the designation made at said processing re-designating step, said second processing being different from the first processing and associated with the type of input operation specified at said operation specifying step.

7. The method according to claim 6, further comprising a display control step of displaying results of the processing executed at said first and second processing steps on the display unit.

8. The method according to claim 6, further comprising a canceling step of canceling the first processing performed at said first processing step in accordance with the designation made at said processing re-designating step,
wherein, at said second processing step, the second processing is executed after the cancellation of the first processing at said canceling step.

9. The method according to claim 7, wherein, at said display control step, an icon, which is for designating whether processing result of the first processing is to be accepted or not, is displayed on the display unit together with the result of processing of the first processing; and
if the fact that the result of processing is not to be accepted has been made by an input operation by the input unit, then a designation at said processing re-designating step is made in such a manner that processing different from the first processing is executed.

10. The method according to claim 6, wherein, at said operation specifying step, the type of input operation is specified based upon in what area on a screen displayed on the display unit the input operation has been made.

11. A computer program product comprising a computer usable medium having computer readable program code means embodied in said medium for an information processing method executed by an information processing apparatus having an input unit and a display unit for implementing a graphical user interface, said product including:
first computer readable program code means for specifying a type of input operation performed by the input unit;
second computer readable program code means for executing first processing associated with the specified type of input operation;
third computer readable program code means for making a re-designation in such a manner that processing different from the first processing is executed; and
fourth computer readable program code means for executing second processing in accordance with the re-designation, said second processing being different from the first processing and associated with the specified type of input operation.

12. The computer program product according to claim 11, further comprising fifth computer readable program code means for displaying results of the first and second processing on the display unit.

13. The computer program product according to claim 6, further comprising sixth computer readable program code means for canceling the first processing in accordance with the re-designation,
wherein said fourth computer readable program code means executes the second processing after the cancellation of the first processing.

14. The computer program product according to claim 12, wherein said fifth computer readable program code means displays an icon, which is for designating whether processing result of the first processing is to be accepted or not, on the display unit together with the result of processing of the first processing; and
if the fact that the result of processing is not to be accepted has been made by an input operation by the input unit, then said third computer readable program code means makes a re-designation in such a manner that processing different from the first processing is executed.

15. The computer program product according to claim 11, wherein said first computer readable program code means specifies the type of input operation based upon in what area on a screen displayed on the display unit the input operation has been made.
